(19) United States
(12) Patent Application Publication
(10) Pub. No.: US 2022/0204055 A1
(43) Pub. Date: Jun. 30, 2022

(54) OPTIMIZATION OF PLANNING TRAJECTORIES FOR MULTIPLE AGENTS

(71) Applicant: Waymo LLC, Mountain View, CA (US)

(72) Inventors: Michael Fiore Watterson, San Francisco, CA (US); Jaime Fernandez Fisac, Princeton, NJ (US); Stephane Ross, San Jose, CA (US)

(21) Appl. No.: 17/199,305

(22) Filed: Mar. 11, 2021

Related U.S. Application Data
(60) Provisional application No. 63/132,442, filed on Dec. 30, 2020.

(51) Int. Cl. B60W 60/00; G05D 1/02

(52) U.S. Cl. CPC B60W 60/00276; B60W 2554/404; G05D 1/0214

(57) ABSTRACT

Methods, systems, and apparatus, including computer programs encoded on a computer storage medium, for optimizing a future trajectory of a vehicle. In one aspect, a method comprises obtaining respective initial future trajectories for a vehicle navigating in an environment and for each of the other agents in the vicinity of the vehicle for a future time period; obtaining respective cost functions and linearized dynamic functions for the vehicle and the other agents; performing a backward pass through the time steps starting from the last time step until the current time step to generate a respective optimal agent policy for the vehicle; and generating an optimized future trajectory for the vehicle by performing a forward pass through the time steps starting from the current time step until the last time step to select a respective action generated from the respective optimal agent policy for the vehicle at each time step.

### CROSS-REFERENCE TO RELATED APPLICATION

This application claims priority to U.S. Provisional Application No. 63/132,442, filed on Dec. 30, 2020. The disclosure of the prior application is considered part of and is incorporated by reference in the disclosure of this application.

### BACKGROUND

This specification relates to autonomous vehicles.

Autonomous vehicles include self-driving cars, boats, and aircraft. Autonomous vehicles use a variety of on-board sensors and computer systems to detect nearby objects and use such detections to make control and navigation decisions.

### SUMMARY

This specification describes a system implemented as computer programs on-board a vehicle that can optimize trajectories planned for a plurality of agents in an environment. The optimization assumes the plurality of agents are interactive in the environment, i.e., an action taken by one of the plurality of agents will influence the actions taken by other agents. The plurality of agents can be any object in the environment, including the vehicle itself.

In general, one innovative aspect of the subject matter described in this specification can be embodied in methods that include: obtaining an initial future trajectory for a vehicle navigating through an environment that includes a plurality of agents; obtaining respective initial future trajectories for each of the one or more other agents in the environment that each starts from the current time step and defines respective states of the agent at each of the plurality of time steps that are after the current time step; obtaining, for each of the plurality of agents, data defining a respective cost function of the agent at each of the plurality of time steps that measures a quality of the state of the agent at the time step; for each agent and for each time step, linearizing a respective dynamics function that receives at least a state of the agent and an action to be performed by the agent at the time step and predicts a state of the agent at a following time step; performing a backward pass through the time steps starting from the last time step in the respective initial future trajectories until the current time step; and generating an optimized future trajectory for the vehicle by performing a forward pass through the time steps starting from the current time step until the last time step to select a respective action generated from the respective optimal agent policy for the vehicle at each time step.

The plurality of agents includes the vehicle and one or more other agents, and the initial future trajectory starts from a current time step and defines respective states of the vehicle at each of a plurality of future time steps that are after the current time step.

At each time step during the backward pass, the method includes: generating a respective value function at the time step for each agent of the plurality of agents from at least the respective cost function for the agent at the time step; and generating a respective optimal agent policy for each agent of the plurality of agents at the time step by minimizing the value function for the agent at the time step based on the linearized dynamics function, wherein the respective optimal agent policy for each agent at the time step depends on states of the plurality of agents at the time step.

Particular embodiments of the subject matter described in this specification can be implemented so as to realize one or more of the following advantages.

The described techniques can predict optimized future trajectories for each of a plurality of agents interacting with each other in an environment based on minimizing cost functions taking as input actions of the plurality of agents at each time step in a future time period.

Because the described techniques account for interactions between agents in the environment when refining possible future trajectories for the agents, an on-board system for a vehicle that uses the described techniques can improve optimizing future trajectories planned for the vehicle as compared to a counterpart system that assumes non-interactive agents in the environment. The described techniques can explore possible future trajectories for the vehicle in a larger solution space to mimic human driving scenarios. For example, an optimized future trajectory planned for the vehicle using the described techniques may be considered as impossible (i.e., the optimized future trajectory might intersect predicted trajectories of other agents in the environment) by the counterpart system assuming agents are non-interactive. The computational cost remains feasible for the on-board system to make predictions efficiently for each time step, even though the number of possible future trajectories for all the agents in the environment that need to be searched increases.

The described techniques can substantially avoid planning a future trajectory for a vehicle that is uncomfortable for a human passenger in the vehicle, unexpected for other human drivers of other vehicles and other agents, or both. For example, the system can avoid planning a future trajectory for the vehicle to abruptly accelerate in order to overtake an agent and switch lanes; instead, the system can plan a future trajectory for the vehicle to change lanes after the agent if the system determines that the agent will accelerate after seeing the vehicle's turning signal. Because a system that implements the described techniques will not plan future trajectories for the vehicle that require sudden changes in states (e.g., velocity, acceleration, and orientation), the vehicle will move more naturally, e.g., more like a vehicle operated by a human driver, and other human drivers in other agents in the vicinity of the vehicle will not be surprised by the vehicle's behavior. The future trajectories for the vehicle generated using the described techniques can therefore be safer to take in the environment.

The described techniques can further adjust optimized future trajectories planned for the vehicle and other agents to account for other agents in the vicinity of the vehicle taking trajectories that are different from the originally planned optimized future trajectories for those agents, i.e., a given agent moves along a different path instead of the optimized future trajectory predicted by the system for the given agent. The described techniques can determine a difference between the trajectory taken by an agent and the originally planned optimized future trajectory for the agent at a given time step in a future time period, and calculate adjusted, optimized future trajectories different from the originally optimized future trajectories for other agents at the time step. That is, the described techniques are robust against differences/errors between the originally optimized future optimized trajectories for some agents and trajectories that end up being taken by the agents for the time step.

Alternatively or in addition, the system implemented with the described techniques can predict optimized future trajectories for agents in a future time period by reusing the obtained optimized trajectories planned for each agent in previous time steps. This allows the on-board system to perform the planning process faster and reduces the computation costs for the on-board system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example on-board system.

FIG. 2 is a block diagram of an example trajectory optimization subsystem.

FIGS. 3A-3C are illustrative figures of scenarios for an on-board system with or without assuming agents in an environment are interactive.

FIG. 4 is an example scenario for optimizing trajectory for a vehicle using the trajectory optimization subsystem.

FIG. 5 is a flow diagram of an example process for optimizing a trajectory of a vehicle.

FIG. 6 is a flow diagram of an example backward pass and an example forward pass for the process of optimizing a trajectory for a vehicle.

Like reference numbers and designations in the various drawings indicate like elements.

### DETAILED DESCRIPTION

This specification describes how to optimize a future trajectory that has been initially planned for an autonomous vehicle navigating through an environment when other agents are in the vicinity of the vehicle. The other agents may be, for example, pedestrians, bicyclists, or other vehicles.

In the following specification, the autonomous vehicle is also referred to as a vehicle and is described as being one of a plurality of agents in the environment. Agents that are not the autonomous vehicle, i.e., pedestrians and other vehicles, are referred to as other agents.

The environment can be a simulated environment or a real-world environment.

For a simulated environment that is simulating a vehicle navigating through a real-world environment with other agents in the vicinity, the future trajectories can be optimized and stored by a system implemented with one or more computers in one or more locations. The system can utilize the stored optimized future trajectories to generate training data for the on-board system, or to evaluate/test the control subsystem of the vehicle for deployment in a real-world environment, or both.

For a real environment, the future trajectory planned for the vehicle is optimized in real time by an on-board system of the vehicle, and used to control the vehicle's motion. That is, the on-board system can cause the vehicle to follow the optimized future trajectory.

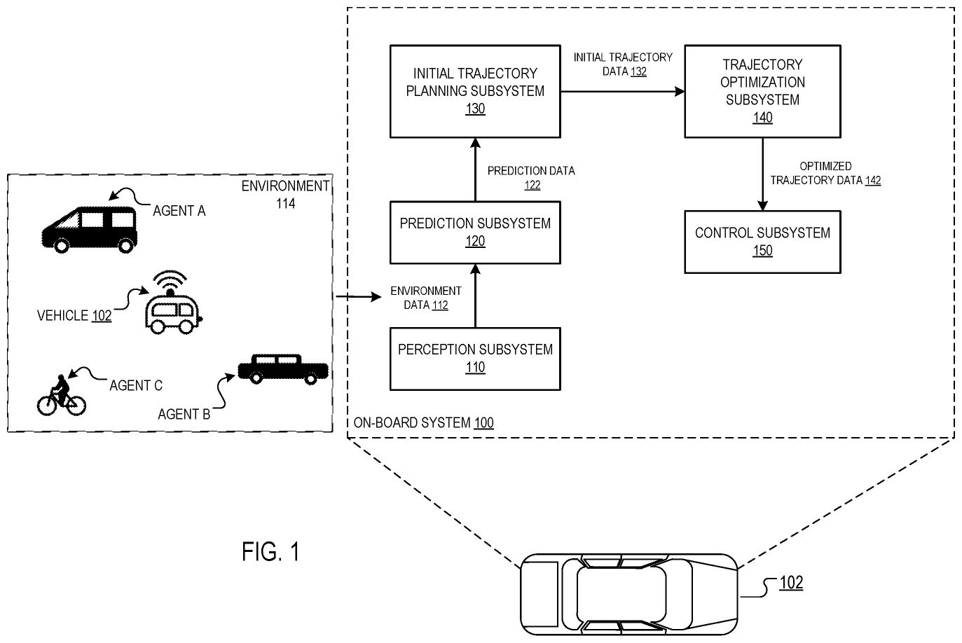

FIG. 1 is a block diagram of an example on-board system 100. The on-board system includes a perception subsystem 110, a prediction subsystem 120, an initial trajectory planning subsystem 130, a trajectory optimization subsystem 140, and a control subsystem 150.

The on-board system 100 is composed of hardware and software components, some or all of which are physically located on-board a vehicle 102 navigating through an environment 114. Although the vehicle 102 in FIG. 1 is depicted as an automobile, and the examples in this specification are described with reference to automobiles, in general, the vehicle 102 can be any kind of vehicle. For example, besides an automobile, the vehicle 102 could be a watercraft or an aircraft.

The on-board system 100 includes a perception subsystem 110 which enables the on-board system 100 to “see” the environment in the vicinity of the vehicle 112. More specifically, the perception subsystem 110 includes one or more sensors configured to receive signals from the environment in the vicinity of the vehicle 102. In some implementations, the received signals can be reflected electromagnetic waves, or visible light. For example, the perception subsystem can include one or more laser sensors (e.g., LIDAR sensors) that are configured to detect reflections of laser light. As another example, the perception subsystem 110 can include one or more radar sensors that are configured to detect reflections of radio waves. As another example, the perception subsystem 110 can include one or more camera sensors that are configured to detect reflections of visible light.

The perception subsystem 110 repeatedly (i.e., at each of multiple time points) captures raw sensor data which can indicate the directions, intensities, and distances traveled by reflected signals.

The on-board system 100 can use the raw sensor data to generate environment data 112 that characterizes states for all agents including the vehicle in the environment 114. In particular, the environment data 112 includes data that characterizes any agents that are present in the vicinity of the vehicle 102, i.e., a minivan labeled as agent A, a limousine labeled as agent B, and a bicyclist labeled as agent C. More generally, an agent in an environment can be any moving object that can influence the future trajectory of other agents in the environment.

In particular, at any given time step during the operation of the vehicle 102, the environment data 112 characterizes the states of all agents at the current time step, i.e., identifies locations of all agents relative to a reference coordinate. In some implementations, the state of an agent also includes at least one of the orientation, velocity, acceleration, size, or shape of the agent.

To track the historical trajectory of an agent in the environment in the vicinity of the vehicle 102, the on-board system 100 can maintain (e.g., in a physical data storage device) historical data defining the historical trajectory of the agent up to the current time point. The on-board system 100 can use the environment data 112 continually generated by the perception subsystem 110 to continually update (e.g., every 0.1 seconds) the historical data defining the historical trajectory of the agent. At a given time point, the historical data may include data defining: (i) the respective historical trajectories of agents in the vicinity of the vehicle 102, and (ii) the historical trajectory of the vehicle 102 itself, up to the given time point.

At any given time point, one or more other agents in the environment may be in the vicinity of the vehicle 102. The other agents in the vicinity of the vehicle 102 may be, for example, pedestrians, bicyclists, or other vehicles. The on-board system 100 uses a prediction subsystem 120 to continually (i.e., at each of multiple time points) generate prediction data 122 which characterizes some or all of the other agents in the vicinity of the vehicle 102. For example, the prediction data 122 can represent initially predicted future trajectories for the other agents for the current time step in a future time period. The prediction system 120 can generate the prediction data 122 in any of a variety of ways, e.g., using statistical techniques, using one or more machine learning models, and so on.

To generate prediction data 122 that represents initial trajectories predicted for other agents in the environment, the prediction subsystem 120 takes as input the stored historical trajectories and predicts initial trajectories of agents, i.e., trajectories starting from the current time step and continuing over a future time period.

The on-board system 100 also includes an initial trajectory planning subsystem 130. The initial trajectory generation subsystem 130 implements software that is configured to repeatedly (i.e., at each of multiple time points) generate initial trajectory data 132 for the vehicle from the current time step in a future time period. The initial trajectory data 132 includes data representing an initially planned future trajectory for the vehicle for the future time period. For example, the initial trajectory planning subsystem 130 can generate the initially planned future trajectory for the vehicle using conventional planning techniques conditioned on the current state of the environment, intended route data for the vehicle, and, in some cases, the prediction data 122.

The length of the future time period for which the future trajectories are generated is generally fixed but can be, e.g., a few seconds, a few minutes, or a few hours.

In some implementations, the initial trajectory data 132 includes both the initially planned future trajectory for the vehicle, and respective predicted trajectories for each of the some or all of the other agents in the vicinity of the vehicle. In some implementations, the initial trajectory data 132 only includes data representing the initially planned future trajectory for the vehicle.

The initially planned future trajectory for the vehicle includes respective states for the vehicle at each time step starting from the current time step and continuing until the last time step in the future time period. The initially planned future trajectory for the vehicle can also include actions or decisions to be taken by the vehicle in the future time period. For example, yielding (e.g., to pedestrians), stopping (e.g., at a “Stop” sign), passing other vehicles, adjusting vehicle lane position to accommodate a bicyclist, slowing down in a school or construction zone, merging (e.g., onto a highway), and parking.

The on-board system 100 can provide the initial trajectory data 132 to the trajectory optimization subsystem 140. The trajectory optimization subsystem 140 implements software programs that are configured to receive initial trajectory data 132 and generates optimized trajectory data 142 that defines optimized future trajectories for the vehicle and the other agents for the future time period starting from the current time step in the environment 114. To generate the optimized trajectory data 142, the trajectory optimization subsystem 140 assumes that each of the plurality of agents in the environment interact with each other—each planned future trajectory of an agent is adjustable with respect to future trajectories planned for other agents in the environment.

To generate optimized future trajectories for the vehicle and other agents in the environment, the trajectory optimization subsystem 140 adjusts the initially planned future trajectory of the vehicle and the predicted future trajectories of the other agents in the environment by modeling the interactions of agents during the future time period. That is, the system adjusts the trajectories of the agents in the environment based on how each agent will respond to potential future motions of the other agents. For example, a given agent might slow down and yield if the given agent “sees” that the vehicle ahead is trying to merge into the same lane.

More specifically, for each time step in the future time period, the trajectory optimization subsystem 140 receives as input the initial trajectory data 132 representing the initially planned future trajectories for the vehicle and the predicted trajectories for the other agents, and optimizes the trajectories of all agents in the environment by minimizing cost functions that consider the above-noted interactions between each agent in the environment at the time step. The subsystem 140 then generates optimized trajectory data 142 representing optimized trajectories for both the vehicle and the other agents in the environment after the time step.

In some implementations when the initial trajectory data 132 includes only the initially planned future trajectory for the vehicle, the trajectory optimization subsystem 140 receives as additional input data (i.e., prediction data 122) representing each predicted future trajectory for the corresponding agent in future time steps after the current time step.

After generating optimized trajectory data 142 representing optimized future trajectories for both the vehicle and the other agents, the trajectory optimization subsystem 140 can also determine for a time step in real-time if a given agent is now taking a different trajectory from the obtained optimized future trajectory for the agent for the time step of the future time period. To determine if the agent actually is taking a different trajectory for a time step, in some implementations, the trajectory optimization subsystem 140 takes as input environment data 112 for each time step when optimizing the future trajectories for the vehicle and other agents in the future time period. The trajectory optimization subsystem 140 can determine the difference/error between the taken trajectory and planned optimized trajectory for the agent at the time step by comparing historical data representing trajectory taken by an agent and the planned optimized trajectory for the agent for the time step, and take into consideration the difference/error when generating optimized future trajectories for other agents in the environment for the time step, i.e., the subsystem 140 can adjust the optimized future trajectories predicted for other agents at the time step based on the determined difference/error, or can keep the originally planned optimized trajectories for other agents unchanged but compensate/offset the difference/error when controlling the vehicle for the time step.

The on-board system 100 can provide to the control subsystem 140 the optimized trajectory data 142 that represents the optimized future trajectory for the vehicle 102. The control subsystem 140 generates control signals to control actions of the vehicle 102 based on the optimized future trajectory from the optimized trajectory data 142 for the vehicle for each time step from the current time step in the future time period. In some cases, the control subsystem 140 can further update the optimized future trajectory for the vehicle before using the trajectory to generate control signals.

The actions controlled by the trajectory optimization subsystem 140 can include for example changing velocity, acceleration, and orientation of the vehicle. For example, the subsystem 140 may transmit an electronic signal to a braking control unit of the vehicle to stop the vehicle. In response to receiving the electronic signal, the braking control unit can mechanically apply the brakes of the vehicle and stop the vehicle.

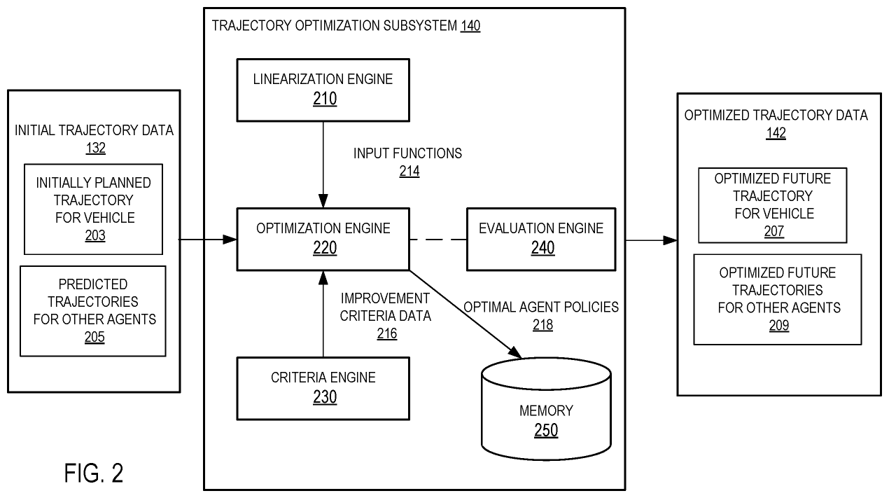

FIG. 2 is a block diagram of an example trajectory optimization subsystem 140.

As described above, the on-board system 100 provides the initial trajectory data 132 to the trajectory optimization subsystem 140.

The trajectory optimization subsystem 140 includes an optimization engine 220, a linearization engine 210, and memory 250. In some implementations, the subsystem 140 further includes a criteria engine 230 and an evaluation engine 240.

The initial trajectory data 132 includes the initially planned trajectory for the vehicle 203 in a future time period, and predicted trajectories for other agents 205 in the future time period. In the following description both trajectories for the other agents and the trajectory for the vehicle are together referred to as joint trajectories, i.e., trajectories for all the agents (i.e., including the vehicle) in the environment during the future time period. For example, the initial planned trajectory for the vehicle 203 and the predicted trajectories for other agents 205 are together referred to as initial joint trajectories for all agents in the environment at the current time step of the future time period. As another example, the optimized future trajectory for the vehicle 207 and the optimized future trajectories for other agents are together referred to as optimized joint trajectories for all agents in the environment in the future time period.

Before optimizing the received initial joint trajectories of all agents at a time step, the linearization engine 210 linearizes respective nonlinear dynamics functions for all agents in the environment. The nonlinear dynamics functions are nonlinear functions that describe physical motions (e.g., trajectories) of agents based on respective current states and control inputs for each time step. The nonlinear dynamics functions can be pre-determined by the user and stored in the memory 250. The linearization engine 210 can linearize the nonlinear dynamics functions by taking first-order approximations (i.e., first-order derivatives) of the respective nonlinear dynamics functions with respect to respective states and control inputs from the received initial joint trajectories at each time step, respectively. More specifically, the respective linearized dynamics functions in a linear form take as input the joint states (i.e., states for all agents) and joint control inputs (i.e., control actions predicted to be taken) of all agents for the time step.

Specifically, the linearized dynamics functions can be described as below:

x(t+1)=A(t)x(t)+B(t)u(t)+c(t), equation (1)

where time step t=0, . . . , T−1, and T represents the time step at the end of the total future time period. x(t) represents a state of an agent at the time step t, or joint states of all agents in the environment at the time step t. Similarly, u(t) represents an agent policy of an agent, or agent policies for all agents at the time step t. Each state of an agent or an agent policy has a respective dimension, e.g., a dimension of 2, 3, or 6 and above. All agents are not assumed decoupled in the equation (1), thus the coefficient matrices A(t) and B(t) are not necessarily diagonal.

According to respective linearized dynamics functions, the linearization engine 210 provides functional forms for respective quadratic time-dependent cost functions for all agents in the environment. The quadratic time-dependent cost functions are used to measure the quality of each future trajectory for each agent in the environment for the feature time period. For example, each cost function can be defined to represent how many control inputs with respective force magnitudes need to be applied for a respective trajectory of each agent in the environment. The system can optimize some or all trajectories by minimizing the cost functions. The cost functions can be pre-determined by the user and stored in the memory 250. To obtain respective quadratic cost functions, the linearization engine 210 takes first and second-order approximations (i.e., first-order and second-order derivatives) of the respective nonlinear cost functions with respect to respective states and control inputs for each agent from the received initial joint trajectories at each time step. Similarly, the respective quadratic cost functions take as input joint states and joint actions of all agents for the time step, and output respective costs for all agents for the time step.

Specifically, the quadratic time-dependent cost function for an agent i at time step t in the future time period can be described as below:

F_{c}_{ᵢ}(t)=½x(t)^{T}Qᵢ(t)x(t)+qᵢ(t)^{T}x(t)+x(t)^{T}Mᵢ(t)u(t)+½u(t)^{T}Rᵢ(t)u(t)+rᵢ(t)^{T}u(t)+eᵢ(t), equation (2)

where Qᵢ(t), qᵢ(t), Mᵢ(t), Rᵢ(t), rᵢ(t), and eᵢ(t) are coefficient matrices with respective dimensions. As shown in equation (2), the cost function F_{c}_{ᵢ}(t) at time step t is a function of the joint states and agent policies for all agents in the environment for the time step.

In some implementations, the system can receive input data representing the dynamics functions and cost functions when receiving a request for optimizing the future trajectory of the vehicle. In some implementations, the functional forms of dynamics functions and cost functions are pre-determined in the memory 250 so that the linearization engine 210 can generate both linearized dynamics functions and quadratic cost functions offline, i.e., without receiving the request for optimizing future trajectories. In some implementations, the system can directly receive data representing the linearized dynamics functions and quadratic cost functions for each agent in the environment.

The subsystem 140 then provides to the optimization engine 220 the input functions 214 representing respective linearized dynamics functions and quadratic cost functions for all agents in the environment. As both linearized dynamics functions and quadratic cost functions are time-dependent, the coefficients for each linearized dynamics functions and quadratic cost functions at each time step depends on the respective received initial trajectories. That is, each linearized dynamics function and quadratic cost function at a different time step can thus have different coefficients.

Based on the received initial trajectory data 132 representing initial joint trajectories and the input functions 214, the subsystem 140 optimizes the initial joint future trajectories and outputs respective optimized future trajectories for all agents. The trajectory optimization subsystem 140 performs optimization process having both a backward pass and a forward pass. In some implementations, the optimization process is iterative.

During the backward pass, the subsystem 140 starts from the last time step in the time period and proceeds backward through the time steps in the time period until reaching the current time step. At each particular time step, the subsystem 140 minimizes cost functions, or value functions, for all agents from the particular time step to a preceding time step. The value functions each can be derived from a respective cost function, and output at least a cost-to-go based on the current state of an agent from the current time step until the last time step in the time period. For example, the value function of an agent for the time step represents a sum of costs of the trajectory for the agent from the current time step until the last time step in the time period.

Specifically, the value function for an agent i at time step t in the future time period can be described as below:

Fᵥ_{ᵢ}(t)=½x(t)^{T}Wᵢ(t)x(t)+wᵢ(t)^{T}x(t)+vᵢ(t), equation (3).

where Wᵢ(t), wᵢ(t), and vᵢ(t) are coefficient matrices for the agent at the time step, and the time-dependent value function for the agent is a function of the joint states of all agents in the environment at the time step. Particularly, the value function Fᵥ_{ᵢ}(t) for an agent i at the last time step T in the backward pass can be identical, or of a constant bias, as the cost function F_{c}_{ᵢ}(t) for the agent, because agent policies are null at the last time step and can be eliminated from the cost function. The coefficient matrices of the value function and the cost function for the last time step can be matched that as below:

Wᵢ(T)=Qᵢ(T),wᵢ(T)=qᵢ(T),vᵢ(T)=eᵢ(T), equation (4).

During the backward pass, the system optimizes a value function for each time step, in which each value function receives as input at least a corresponding agent state for the time step. Through an optimized value function at a time step, the system can obtain a respective minimal cost-to-go (i.e., an evaluation of the optimized value function) from the time step based on respectively-received agent states. The system can minimize a value function for an agent at the current time step equivalently by minimizing a cost function for the agent at the time step and a value function for the agent at the succeeding time step. Although the value function for the agent for the succeeding time step has already been optimized when optimizing the value function for the current time step during the backward pass, the output of the optimized value function (i.e., a cost-to-go, or an evaluation of the optimized value function) for the succeeding time step might be different, because, for example, the agent might reach a different state at the succeeding time step according to different actions taken by the agent before the succeeding time step.

The cost functions for all agents take into consideration that all agents interact with each other at each time step. That is, a given cost function for an agent is subject to other agent's cost functions, actions, behaviors, or trajectories. The subsystem 140 then obtains respective optimal agent policies 218 for all agents at each time step in the future time period. The on-board system 110 provides and stores optimal agent policies 218 in the memory 250. The optimal agent policies 218 take as input joint states of all agents in a given time step in the future time period, and are used to generate actions for all agents for the time step in the forward pass. The optimization during the backward pass is described below in more detail.

During the forward pass, the subsystem 140 determines respective actions to be taken by all agents using the obtained optimal agent policies 218 from the current time step to a next time step starting from the current time step to the last time step of the time period. The subsystem 140 then generates candidate joint future trajectories for all agents at each time step based on the respective actions to be taken by all agents at the beginning of the corresponding time step. The subsystem 140 can implement the forward pass using line search. The subsystem 140 eventually generates candidate joint future trajectories for the entire future time period by merging the optimized joint future trajectories for each time step. Generating candidate future trajectories will be described in more detail.

Before outputting the candidate trajectories as the optimized future trajectories for the entire future time period, the subsystem 140 determines if the candidate trajectories obtained in the optimization process satisfy criteria such as improvement criteria and convergence criteria. For example, candidate trajectories obtained through the forward pass should satisfy one or more improvement criteria with respect to the cost functions for the agents, e.g., at least a threshold number of the agents should have an improved performance regarding respective cost functions when taking the respective candidate trajectories. The criteria engine 230 can provide improvement criteria data 216 characterizing the improvement criteria. If the obtained candidate joint future trajectories are not improved according to the improvement criteria, the subsystem 140 will recalculate candidate trajectories in the forward pass using different internal parameters for the forward pass.

The subsystem 140 can also require that the candidate trajectories obtained for all agents through the optimization process satisfy one or more convergence criteria, i.e., optimization processes using the backward and forward pass should yield substantially similar candidate joint future trajectories between adjacent line search solutions, or searched solutions during different line search processes using different internal parameters. The convergence criteria can be pre-determined by the user and stored in the memory 250. In some implementations, the subsystem 140 can instruct the evaluation engine 240 to determine if the obtained candidate joint future trajectories are converged.

If the obtained candidate joint future trajectories are not converged according to the convergence criteria, the subsystem 140 will instruct the optimization engine 220 to restart another optimization process including the backward and forward process with different line search initializations (i.e., pre-determined internal parameters for the line search process such as average time step size). This process is iterative and stops when either the converged solutions are found or a pre-determined maximum number of iterations is reached.

If the candidate trajectories satisfy at least one of the improvement criteria and convergence criteria, the subsystem 140 will output the candidate joint future trajectories as optimized trajectory data 142 for the control subsystem 150. The control subsystem 150 receives from the optimized trajectory data 142 representing the optimized future trajectories for the vehicle, and generates control signals to control the vehicle for the future time period.

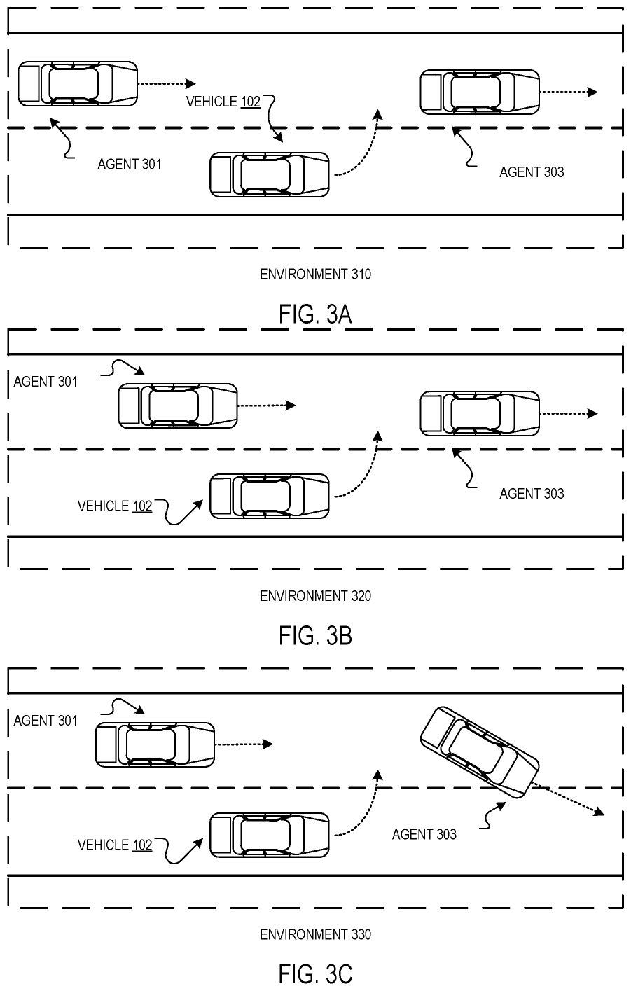

FIGS. 3A-3C are illustrative figures of scenarios for an on-board system 100 with or without assuming agents in an environment are interactive.

As shown in FIG. 3A, the agents in the environment 310 include the vehicle 102, agent 301, and agent 303. Assume that the vehicle 102 needs to change to the upper lane. The on-board system 100 of the vehicle first observes the states of all agents and calculates initially-obtained joint trajectories for all agents, and optimizes a future trajectory for the vehicle 102 to change lanes.

As shown in FIG. 3B, for an on-board system that assumes that all agents in the environment 310 are not interactive, the system may not be able to find it possible for the vehicle to change to the upper lane between the two agents 301 and 303 when detecting that the agent 301 is accelerating to approach the agent 303. The system may control the vehicle either to accelerate and pass the agent 303, or decelerate and wait until the agent 301 passes it, before turning into the upper lane.

However, as shown in FIG. 3C, the agent 301 may also “see” the vehicle's turning signal, and decelerate to allow enough space for the vehicle 102 to turn in, or the agent 303 may as well “see” the vehicle's turning signal and change to the lower lane. By considering the interactions between agents, the on-board system 100 may find it now possible to change into the upper lane between the two agents, as the other agents are creating space interactively.

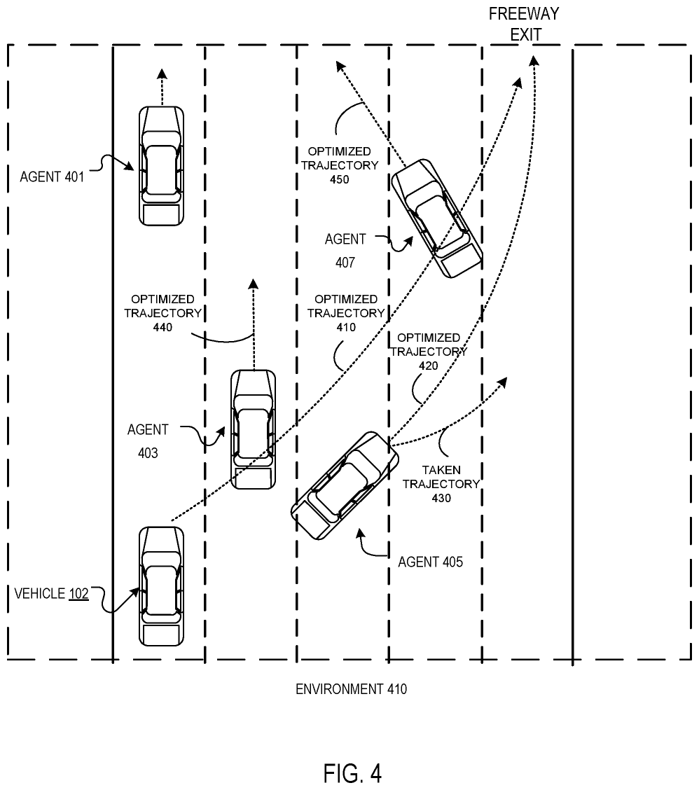

FIG. 4 is an example scenario for optimizing trajectory for a vehicle 102 using the trajectory optimization subsystem 140.

Assume the vehicle 102 is now navigating in an environment 410 (e.g., freeway) toward a preset destination or a final state following a trajectory until the current time step. The trajectory is obtained and optimized by the on-board system 100 as described above. According to the trajectory and the current state of the vehicle 102, the vehicle now needs to exit from the freeway through the next freeway exit to follow a desired path, e.g., a fastest route. The on-board system 100 starts to obtain an optimized trajectory for the vehicle to follow, from the current time step to the last time step in a future time period, for staying in the desired path. The future time period, for example, can be a total time length between the current time and the future time when the vehicle exits the freeway. As another example, the future time period can be a total time of a few seconds, minutes, or hours from the current time.

To obtain the optimized trajectory for the vehicle in the future time period, the system 100 first determines the quantity, current states, and historical trajectories of other agents in the vicinity of the vehicle 102. For example, as shown in FIG. 4, the system 100 determines that there are three other vehicles 403, 405, and 407 navigating in the vicinity of the vehicle 102. The system 100 does not consider the vehicle 401 as an agent in the vicinity of the vehicle since the vehicle 401 might be too far ahead of the vehicle 102 and is accelerating. The system 100 then determines a respective current state of each agent representing corresponding velocity, acceleration, and orientation. The system 100 predicts an initial trajectory for each of the agents (i.e., vehicles 403, 405, and 407) in the future time period based on the respective current state and historical trajectory for each agent.

The system 100 can receive as input data predicting behaviors of each agent after seeing actions taken by other agents. The agent behaviors can be actions (e.g., accelerating, decelerating, and turning) on the condition of seeing actions taken by other agents. For example, a first agent can accelerate for allowing a second agent behind it to change into the same lane after “seeing” the turning signals of the second agent. The input data can be generated from any conventional statistical methods or artificial intelligence, e.g., machine learning method with one or more neural networks.

In some implementations, the system 100 can receive data representing conditional probabilities of actions for each agent to predict behaviors of the agent based on the current state, the initially predicted trajectory, and historical trajectories of the agent.

Back to referring to FIG. 4, the system 100 obtains an initial trajectory for the vehicle 102 according to the predicted trajectories of other agents 403, 405, and 407 subject to some constraints, e.g., the joint trajectories of all agents do not intersect to avoid collisions. The initial trajectory for the vehicle 102 might require the vehicle to slow down and change to the right-most lane after the other agents have passed the vehicle, as the other agents are in states such that the system 100 may find it impossible for the vehicle to exit the freeway keeping the same speed if the other agents are strictly following the respective initially-predicted trajectories.

However, because the system 100 considers the interactions between all agents in order, i.e., all agents take turns to take actions following the order and each agent takes actions conditioned by actions taken by other agents preceding the agent in the order.

Specifically, for N agents in an environment, each agent i is assigned to a respective position oᵢ(t) from {1, . . . , N} in an order o(t) of taking actions at the time step t. Agent i with a position oᵢ(t)=1 first takes an action uᵢ(t) at the time step, and the following agent j with a position oⱼ(t)=2 takes an action uⱼ(t) based on the action uᵢ(t) as declared by the agent i for the time step.

The order of taking actions for all agents can be pre-determined by the user, or generated in real-time. The orders for all agents can be different at different time steps. The order of the agents can be generated, for example, randomly. As another example, the order of the agents can be generated based on the likelihood of one or more agents of the plurality of agents to lead the interaction between all agents in the future time period based on, for example, their current states, their historical trajectories, or both.

As shown in FIG. 4, assume that vehicle 102 is the first agent in the order and flashes a right turn signal light for the time step. According to the received behavior data and the order for the time step, the system predicts that the first vehicle 403 (i.e., the second agent in the order) will react to “seeing” the vehicle 102's right turn signal by accelerating to create space for the vehicle 102 to move into the same lane. The system also predicts that the second vehicle 405 (i.e., the third agent in the order) will decelerate and change to the right-most lane after “seeing” the right turn signal of the vehicle 102 and the acceleration of the first vehicle 403. The system further predicts that the third vehicle 407 (i.e., the fourth agent in the order) will switch to the left lane after “seeing” the actions of the vehicle 102, the first vehicle 403, and the second vehicle 405.

For each time step from the current time step to the last time step of the future time period, the system 100 generates respective costs for trajectories of all agents using respective cost functions. The cost function for each agent at each time step depends on the actions taken by other agents before the agent in the order at the time step. The system 100 outputs optimized trajectories for all agents by minimizing the respective costs for each time step.

The cost function for each agent at a time step measures a quality of a trajectory for the agent, e.g., how many actions need to be taken by the agent to follow the trajectory, how drastically an agent's states will change if the agent follows the trajectory, and how many resources it would cost, e.g., fuel or battery consumption, for an agent to follow the trajectory. The cost function can also include received data representing agents' behaviors, e.g., the cost for agents controlled by aggressive human drivers to yield after “seeing” actions taken by other agents can be higher than that for agents controlled by polite human drivers.

Back to referring to FIG. 4, the system 100 generates optimized trajectories that satisfy improvement criteria and convergence criteria for all agents, e.g., optimized trajectory 410 for the vehicle 102, optimized trajectories 420, 440, and 450 for agents 405, 403, and 407, respectively. More specifically, the system 100 obtains optimized trajectories for all agents at each time step in a forward pass using line search or binary search, and links the optimized trajectories for all agents at each time step sequentially to output the optimized trajectory 410, 420, 440, and 450 for the entire future time period.

In some cases, one of the agents does not take the optimized trajectory generated from the system 100 at a time step. The system 100 can then determine the difference between the taken trajectory and the optimized trajectory for the agent, and adjust the optimized trajectories for other agents taking actions after the agent according to an order at the time step. For example, at a time step in the future time period, the agent 405 starts to follow a different trajectory 430 deviating from the optimized trajectory 420. The system 100 determines the difference or error between the two trajectories 420 and 430, and adjusts the optimized trajectories of agent 407 at the time step. This is because only agents following agent 405 in the order need to adjust respective optimized trajectories in response to the agent 405's deviation. The system can avoid sequentially propagating the deviation through each of the following agents in the order, by modifying terms using the difference/error in an equilibrium equation. The equilibrium equation represents respective optimized trajectories or respective optimal agent policies in equilibrium for all agents at each time step, which is described in more detail below.

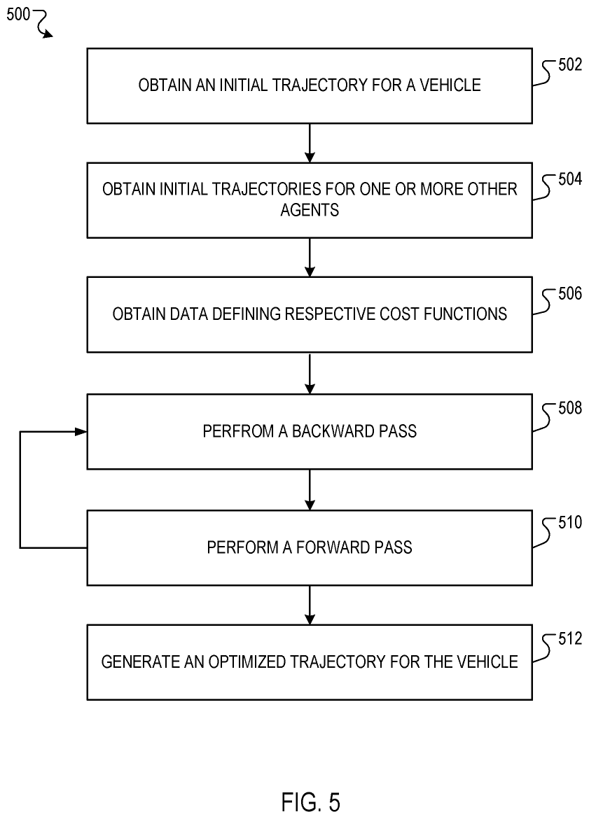

FIG. 5 is a flow diagram of an example process 500 for optimizing a trajectory of a vehicle. For convenience, the process 500 will be described as being performed by a system of one or more computers located in one or more locations. For example, a trajectory optimization system, e.g., the on-board system 100 of FIG. 1, appropriately programmed, can perform the process 500.

Upon receiving data requesting for generating an optimized trajectory for a vehicle navigating in an environment from the current time step. The system 100 obtains an initial future trajectory for a vehicle. (502) The initial future trajectory planned for the vehicle starts from a current time step until the last time step in a future time period. The initial future trajectory defines the respective states of the vehicle at each time step in the future time period.

The system 100 also detects and determines other agents navigating in the vicinity of the vehicle by received data characterizing the other agents. More specifically, the system 100, from environment data that represents the current states of each of the other agents and historical data characterizing trajectories taken by the other agents before the current time step, predicts respective initial trajectories for one or more of the other agents. (504) The predicted initial trajectories each starts from the current time step and expands the same time length of the future time period.

The system 100 obtains data defining a respective cost function for each agent of all agents in the environment. (506) The cost functions can be generated in a quadratic form with data defining the cost functions receiving as inputs: e.g., current states and control inputs (or actions) for each agent at each time step. In some implementations, the data defining the cost functions includes sampled behaviors for an agent after seeing actions taken by other agents, data characterizing the driving style (e.g., polite or aggressive) of the agent, and respective trajectory costs such as total navigating time, total distance, and fuel or battery consumption. In some implementations, the cost function for the vehicle can be generated offline without receiving requests for the system 100 to generate optimized trajectories for the vehicle.

To generate an optimized trajectory for the vehicle in the future time period, the system 100 performs iteratively a backward pass (508) and a forward pass (510).

During the backward pass through the time steps starting from the last time step in the respective initial joint trajectories until the current time step, the system 100, for each time step and for each agent, generates a respective value function at the time step for the agent based on the respective cost function for the agent at the time step.

Before generating respective value functions for each agent at each time step during the backward pass, the system 100 calculates linearized respective dynamics functions and quadratic cost functions for each agent at each time step, as described above. The respective value functions for each agent depend on the respective linearized dynamics functions and quadratic cost functions.

The system 100 obtains a respective optimal agent policy for each agent at the time step by minimizing the respective value functions of all agents at the time step. The system can apply an agent policy of a respective agent at a time step to generate one or more respective actions for the agent at the time step, and generate one or more respective future trajectories for the agent based on the respective agent policies of the agent for each time step in the future time period can generate. In some implementations, the respective optimal agent policy for an agent can depend on both the states of all agents and actions taken by preceding agents in the order. In equilibrium, the respective optimal agent policy for each agent depends on the current states of all agents at the time step. The backward pass is described in more detail below.

During the forward pass through the time steps starting from the current time step until the last time step, the system 100 selects a respective action for each agent from the respective optimal agent policy at each time step.

The system 100 generates an optimized trajectory for the vehicle for the future time period. (512) In general, the optimized trajectory for the vehicle depends on the respective current states for all agents. In some implementations, the system 100 also predicts optimal trajectories for other agents in the vicinity of the vehicle and adjusts optimized trajectories planned for the vehicle if one or more of the agents navigating away from respective predicted optimized trajectories for the one or more of the agents.

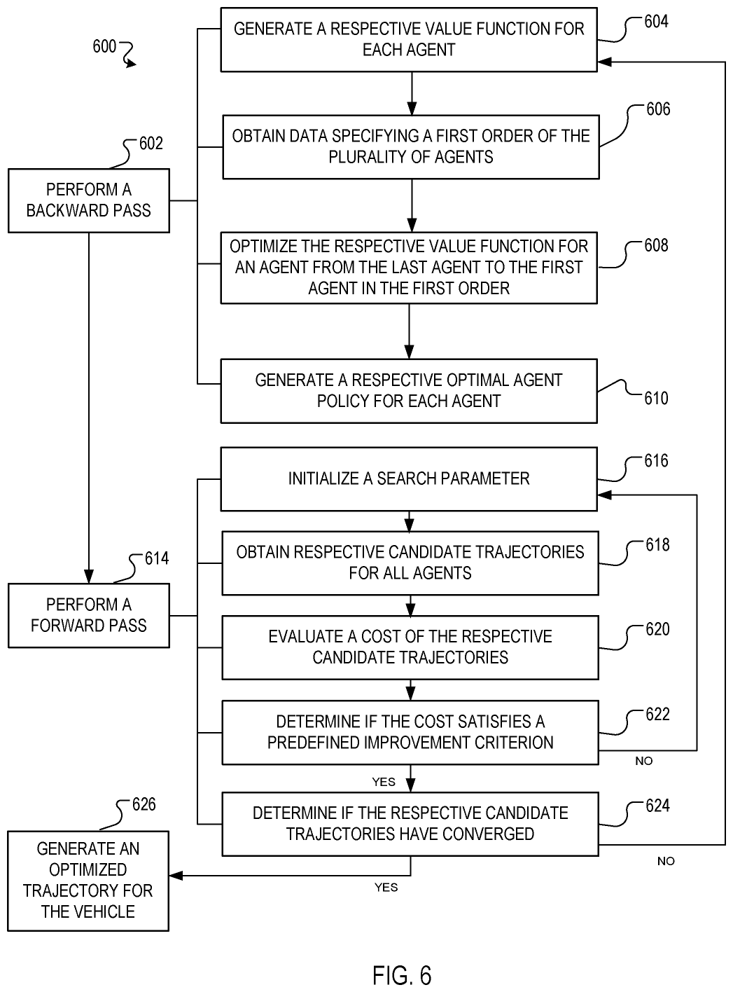

FIG. 6 is a flow diagram of an example backward pass and an example forward pass for the process 600 of optimizing a trajectory for a vehicle. For convenience, the process 600 will be described as being performed by a system of one or more computers located in one or more locations. For example, a trajectory optimization system, e.g., the on-board system 100 of FIG. 1, appropriately programmed, can perform the process 600.

To generate optimized trajectories for the vehicle and other agents in the environment for a future time period, the system 100 performs a backward pass and a forward pass for all time steps of the future time period.

Referring back to the backward pass at time steps from the last time step to the current time step in the future time period (602), the system 100 first generates respective value functions of all agents at each time step. (604) The respective value function for each agent at the time step depends on the corresponding cost function at the time step. For the last time step, the respective value function for each agent includes the respective cost function for the agent. For time steps other than the last time step, the respective value function for each agent at each time step includes the respective cost function for the agent at the time step and the respective value function for the agent at a following time step.

When generating the respective value functions, the system 100 assumes that each agent takes an action in an order or a sequence such that each agent reacts to actions taken by other preceding agents in the order. That is, the system 100 obtains data specifying a respective order of the plurality of agents for each time step. (606) For example, the system 100 obtains data specifying a first order at a given time step during the backward pass, the vehicle is the leader of the first order (i.e., the first agent in the order to take actions), and other agents are followers of the leader according to the first order. The first follower (i.e., the second agent in the first order) takes an action according to the action taken by the vehicle. The second follower (i.e., the third agent in the first order) takes an action according to actions taken by the second agent and the vehicle.

After generating the respective value function, the system 100 optimizes a respective value function for each agent at the time step according to the respective order, yet reversely, i.e., starting from the last agent until the first agent in the order. (608)

For example, the system 100 first optimizes the respective value function for the last agent in the respective order based on agent policies of preceding agents in the order. The preceding agents for the last agent include all agents from the first agent to the second last agent in the order. As another example, the system 100 optimizes the respective value function for the first agent in the respective order with no preceding agents.

The system 100 generates a respective optimal agent policy for each agent according to the order by optimizing the respective value function for the agent. (610) The respective agent policy can be used in the forward pass to determine an action to be taken by the agent at the time step. In general and in equilibrium, the optimal agent policy for each agent of a plurality of agents at the time step depends on the current states of all the agents. Before the system 100 generates an equilibrium equation to obtain respective optimal agent policies in equilibrium for each agent at the time step, each of the respective optimal agent policy depends on (i) states of the plurality of agents at the time step, and (ii) the respective agent policy for each of the plurality of agents preceding the agent in the respective order at the time step.

Specifically, the optimal agent policy for agent i in the order at time t can be expressed as:

$${u}_{i}^{*} ( t ) = {K}_{i} ( t ) x ( t ) + {k}_{i} ( t ) + {\sum }_{j < i} {F}_{i , j} ( t ) {u}_{j} ( t ) , \qquad equation ( 5 )$$

where Kᵢ(t) and kᵢ(t) are a column or row of respective coefficient matrices K(t) and k(t), F_{i,j}(t) are a respective scalar of the respective coefficient matrix F(t), and j<i represents every agent j taking actions before the agent i. As shown the equation (5), the optimal agent policy for agent i depends on the joint states of all agents and agent policies for any preceding agents in the order.

The optimal agent policy for each agent in equilibrium can be expressed as:

u^{eq}(t)=K^{eq}(t)ₓ(t)+k^{eq}(t), equation (6)

where K^{eq} and k^{eq} are coefficient matrices. As shown in equation (6), the joint optimal agent policy u^{eq}(t) at time step t depends on joint states x(t) of all agents in the environment at the time step.

The system 100 generates the equilibrium equation by updating respective dynamics functions, cost functions, and value functions for all preceding agents in the order. Specifically, after generating a respective optimal agent policy for an agent in the order, the system 100 can update the above-mentioned equations by replacing an agent policy for the agent with the optimal agent policy obtained as described above.

In some implementations, the system 100 updates, based on the respective optimal agent policy for the agent at the time step, the respective linearized dynamics function, and the respective cost function for each of the plurality of agents at the time step. The updated respective linearized dynamics function and the updated respective cost function both depend on: (i) the states of the plurality of agents at the time step, and (ii) the respective optimal agent policy for each of the plurality of agents preceding the agent in the respective order at the time step. The system 100 then updates, based on the updated linearized dynamics function and cost function, the respective value function for each of the plurality of agents at the time step. Since the first agent in the respective order does not have any preceding agent in the order, the updated value function for the first agent is independent of any optimal agent policies of the plurality of agents for the time step. By updating the above-noted equations after generating optimal agent policy for the first agent in the order, the equilibrium equation is in a form that receives only the current states of all agents as input.

The concept of generating the equilibrium equation relates to the idea of excluding an agent, after generating the optimal agent policy for the agent, from the order before calculating optimal agent policies for other agents preceding the agent in the order. By excluding the agent from the order, the system 100 can consider the actions and states of the agent as known background information, and the total size of the order is decreasing during the backward pass at the time step.

For example, assume there are N agents in the environment when generating the optimal agent policy for the last agent in the order. After obtaining the optimal agent policy for the last agent, the system 100 excludes the last agent from the following optimization process by updating respective linear dynamics functions, cost functions, and value functions for agents preceding the last agent, as described above. That is, by updating, the system embeds the optimal policy for the agent into the optimization process as background or known information when optimizing value functions for other agents in the order. So the total size of the order becomes (N−1) when the system 100 starts to generate optimal agent policy for the second last agent in the order. The original second last agent in the order now becomes the new last agent. When the system 100 optimizes the value function for the first agent of the order, the optimal agent policies of all agents except for the first agent have been embedded as the background information. Now, the optimization of the plurality of agents at the time step becomes equivalent to the optimization of a single agent policy at the time step. By excluding the agent from the order after it has been optimized, the system 100 can achieve higher computation efficiency when performing the backward pass, and can obtain the equilibrium equation for all agents which only takes as input current states of all agents.

In some implementations, the system 100 can update the optimal agent policy for a given agent (not the last agent) in an order based on optimal agent policies for succeeding agents in the order. The updated optimal agent policy for the agent is also referred to as implicit optimal agent policy, which is used to facilitate generating an equilibrium equation for all agents at the time step by forming up the equation solvable using matrix operations. The implicit agent policy does not affect the interactive relation between agents as defined above, thus it does not change the optimal policies obtained for all agents at the time step.

After obtaining the optimal agent policy for the first agent in the order at the time step, the system 100 can combine all optimal agent policies for the time step into a joint optimal agent policy, or the equilibrium equation. The joint optimal agent policy for all agents at each time step receives as input the current states of all agents and output respective actions to be taken for each agent at the time step.

Since the other agents in the vicinity of the vehicle are not controlled by the system 100, they can take different trajectories deviating from the optimized trajectories generated by the system 100 at each time step. As described above, the system 100 can determine, from historical data representing the trajectories taken by each agent and the current state for the agent, if one or more agents takes a different agent policy that deviates from the respective optimal agent policy for the one or more agent. Upon detecting an agent taking an agent policy (or action, or trajectory) different from the optimal agent policy, the optimization 220 can quantify a difference/error between the taken agent policy and the optimal agent policy for the agent at the time step, and update respective optimal agent policies (or optimized future trajectories) for other agents succeeding the agent in the order based on the determined difference/error. In some implementations, the system 100 can update only a portion of the joint optimal policy (e.g., one or more rows or columns of the joint optimal policy matrix, or the equilibrium equation) that has been affected by the deviation of the agent.

More specifically, the optimal agent policy for agent following the agent d in the order of taking actions can be expressed in a linear form derived with the implicit optimal agent policies as below:

u*(t)=K^{eq}(t)x(t)+k^{eq}(t)+F^{dev}(t)(u_{d}(t)−u_{d}^{eq}(t)), equation (7)

where u_{d}(t) represents the agent policy that is actually taken by the agent d at the time step, and u_{d}^{eq} (t) represents the optimal agent policy previously obtained for the agent d during the backward pass for the time step. The coefficient matrix F^{dev}(t) is derived using the implicit optimal agent policies and is zero for all agents preceding the agent d in the order. That is, the system updates optimal agent policies only for agents following the agent d.

After obtaining the joint optimal agent policy for the time step, the system 100 repeats the above-noted process for a time step preceding the time step until the first time step for the future time period.

After performing the backward pass from the last time step until the current time step, the system performs a forward pass at time steps starting from the current time step until the last time step for the future time period. (614)

The system 100 first initializes a search parameter for all time steps of the forward pass. (616) The system 100 searches for candidate trajectories for the vehicle and other agents based on the joint optimal agent policy for the future time period. Generally, the system 100 adopts a line search or binary search method to search for the candidate trajectories. A search parameter is a real number relating to the learning rate for the line search. For example, the search parameter is an integer one.

As described above, the joint optimal agent policy receives as input joint states of all the agents at each time step and outputs a respective action for each agent. The system 100 then updates the candidate action for the vehicle at the time step, through a convex combination of the initial action from the initial future trajectory for the vehicle and a weighted action from the joint optimal agent policy for the vehicle at the time step. The weighted action is the multiplication of the search parameter and the action for the vehicle from the joint optimal agent policy. The system 100 can generate candidate actions for the other agents based on the candidate action for the vehicle at the time step. In some implementations, the system generates candidate actions for the other agents through a similar convex combination using the search parameter, e.g., a summation of a respective weighted action and a respective initial action for each of the other agents at the time step.

The system 100 then generates respective candidate future trajectories for the plurality of agents for each time step. (618) To generate the respective candidate future trajectories, the system 100 first generates states for all agents at the succeeding time step using the updated linearized dynamics functions obtained from the backward pass. As described above, the linearized dynamics function for each agent receives as input the current state and control inputs of the agent for the time step. The following-time-step state for each agent characterizes a respective candidate trajectory for the agent at the time step. The system 100 can sequentially link candidate trajectories for each agent from different time steps during the forward pass to generate respective candidate trajectories for each agent for all time steps.

The system evaluates a cost of the respective candidate future trajectories against the initial future trajectories of the plurality of agents. The system determines if the cost can satisfy at least a predefined improvement criterion. (620) The predefined improvement criterion can be at least one of the following: a cost for a candidate future trajectory of the vehicle decreases, a sum of costs for some of the respective candidate future trajectories of the plurality of agents decreases, or each cost for the respective candidate future trajectories of the plurality of agents at least does not increase, comparing against the costs of initial future trajectories.

In response to determining the cost does not satisfy the improvement criterion, the system 100 updates the search parameter, for example, taking half of the current value of the search parameter, and re-generates respective candidate future trajectories in the forward pass.

In response to determining the cost satisfies the improvement criterion, the system 100 then determines if the respective candidate trajectories have converged according to at least a convergence criterion, as described above. (624) If the respective candidate trajectories have converged, the system 100 generates the optimized trajectory for the vehicle from the converged respective candidate future trajectories, otherwise, the system 100 performs again the backward pass and the forward pass.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining an initial future trajectory for a vehicle navigating through an environment that includes a plurality of agents, the plurality of agents including the vehicle and one or more other agents, and the initial future trajectory starting from a current time step and defining respective states of the vehicle at each of a plurality of time steps that are after the current time step;
obtaining respective initial future trajectories for each of the one or more other agents in the environment that each starts from the current time step and defines respective states of the agent at each of the plurality of time steps that are after the current time step;
obtaining, for each of the plurality of agents, data defining a respective cost function of the agent at each of the plurality of time steps based on a respective state of the agent at the time step;
performing a backward pass through the plurality of time steps starting from the last time step in the respective initial future trajectories until the current time step, comprising at each time step:
generating a respective value function at the time step for each agent of the plurality of agents from at least the respective cost function for the agent at the time step; and
generating a respective optimal agent policy for each agent of the plurality of agents at the time step by minimizing the respective value function for the agent at the time step, wherein the respective optimal agent policy for each agent at the time step depends on the respective states of the plurality of agents at the time step; and
generating an optimized future trajectory for the vehicle by performing a forward pass through the plurality of time steps starting from the current time step until the last time step to select a respective action generated from the respective optimal agent policy for the vehicle at each time step.

2. The method of claim 1, wherein:
for the last time step in the backward pass, the respective value function for each agent includes the respective cost function for the agent, and
for each time step other than the last time step in the backward pass, the respective value function for each agent at the time step includes the respective cost function for the agent at the time step and the respective value function for the agent at a following time step.

3. The method of claim 1, wherein generating the respective optimal agent policy for each agent of the plurality of agents by minimizing the value function for the agent at the time step comprises:
obtaining data specifying a first order of the plurality of agents for the time step; and
generating the respective optimal agent policy for each agent starting from the last agent until the first agent in the first order.

4. The method of claim 3, wherein generating the respective optimal agent policy for each agent starting from the last agent in the first order comprises:
optimizing, according to the first order, the respective value function for the agent at the time step, and
generating, in response to optimizing the respective value function, a respective optimal agent policy for the agent at the time step, wherein the respective optimal agent policy depends on: (i) the respective states of the plurality of agents at the time step, and (ii) the respective agent policy for each of the plurality of agents preceding the agent in the first order at the time step.

5. The method of claim 4, further comprising:
updating, based on the respective optimal agent policy for the agent at the time step, a respective linearized dynamics function for each of the plurality of agents at the time step,
wherein the updated respective linearized dynamics function depends on: (i) the respective states of the plurality of agents at the time step, and (ii) the respective optimal agent policy for each of the plurality of agents preceding the agent in the first order at the time step.

6. The method of claim 5, further comprising:
updating, based on the respective optimal agent policy for the agent at the time step, the respective cost function for each of the plurality of agents at the time step,
wherein the updated respective cost function depends on: (i) the respective states of the plurality of agents at the time step, and (ii) the respective optimal agent policy for each of the plurality of agents preceding the agent in the first order at the time step.

7. The method of claim 4, further comprising:
obtaining, based on the respective optimal agent policy for the agent at the time step, a respective implicit optimal agent policy of each agent succeeding the agent in the first order at the time step, to facilitate generating the respective optimal agent policy for each agent of the plurality of agents at the time step using the respective implicit optimal agent policies.

8. The method of claim 7, further comprising:
generating, using the obtained respective implicit optimal agent policies, an equilibrium equation for obtaining a respective optimal agent policy in equilibrium for each agent at each time step, wherein the obtained respective optimal agent policy in equilibrium for each agent depends on the respective states of the plurality of agents at the time step.

9. The method of claim 6, further comprising:
updating, based on the updated respective linearized dynamics functions and the updated respective cost functions for the plurality of agents at the time step, the respective value function for each of the plurality of agents at the time step.

10. The method of claim 9, wherein, if the agent is the first agent in the first order at the time step, the updated respective value function is independent of respective optimal agent policies for the plurality of agents in the first order at the time step.

11. The method of claim 3, after generating the generating an optimized future trajectory for the vehicle, comprising:
determining, based on the respective optimal agent policy for each agent of the plurality of agents at each time step, if the agent takes an agent policy for the time step that deviates from the respective optimal agent policy for the agent for the time step,
in response to determining the agent takes an agent policy for the time step that deviates from the respective optimal agent policy for the agent, updating the respective optimal agent policies for the agents of the plurality of agents succeeding the agent in the first order at the time step, based on a difference between the agent policy taken by the agent and the respective optimal agent policy for the agent at the time step.

12. The method of claim 1, wherein generating the optimized future trajectory for the vehicle by performing the forward pass, comprises:
initializing a search parameter for the plurality of time steps,
generating, based on the search parameter, respective candidate actions for the plurality of agents at each time step,
generating, based on the respective candidate actions, respective candidate future trajectories for the plurality of agents for the plurality of time steps, and
generating, from the respective candidate trajectories, the optimized future trajectory for the vehicle.

13. The method of claim 12, wherein generating, based on the initialized search parameter, the respective candidate actions for the plurality of agents at each time step, comprising for each time step:
generating, using a convex combination of the respective action and a respective initial action from the initial future trajectory for the vehicle using the search parameter, an candidate action for the vehicle at the time step, and
generating, based on the candidate action for the vehicle at the time step, the respective candidate actions for the rest of the plurality of agents at the time step,

14. The method of claim 13, generating the respective candidate actions for the rest of the plurality of agents at the time step, comprising:
generating respective candidate actions for the rest of the plurality of agents through a convex combination of respective actions from the respective optimal agent policies and initial actions from the respective initial future trajectories for the rest of the plurality of agents using the search parameter.

15. The method of claim 12, wherein generating, based on the respective candidate actions, the respective candidate future trajectories for the plurality of agents for the plurality of time steps comprises for each time step:
obtaining, based on the respective candidate actions and the respective states for the plurality of agents at the time step, respective states for the plurality of agents at a succeeding time step defining the respective candidate future trajectories.

16. The method of claim 15, after generating respective candidate future trajectories, comprising:
evaluating a cost of the respective candidate future trajectories against the respective initial future trajectories of the plurality of agents;
determining the cost satisfies a predefined improvement criterion, and
in response to determining the cost does not satisfy the predefined improvement criterion,
updating the search parameter, and
re-generating respective candidate future trajectories of the plurality of agents for the plurality of time steps.

17. The method of claim 16, wherein the predefined improvement criterion comprise at least one of the following: (i) a cost for a candidate future trajectory of the vehicle decreases, (ii) a sum of costs for some of the respective candidate future trajectories of the plurality of agents decreases, or (iii) each cost for the respective candidate future trajectories of the plurality of agents at least does not increase.

18. The method of claim 12, wherein generating, from the respective candidate trajectories, the optimized future trajectory for the vehicle comprises:
determining, based on a predefined convergence criterion, if the respective candidate future trajectories of the plurality of agents have converged,
in response to determining the respective candidate future trajectories have not converged, performing again the backward pass and the forward pass, and
in response to determining the respective candidate future trajectories have converged, generating the optimized future trajectory for the vehicle from the converged respective candidate future trajectories.

19. A system comprising one or more computers and one or more storage devices storing instructions that are operable, when executed by the one or more computers, to cause the one or more computers to perform operations comprising:
obtaining an initial future trajectory for a vehicle navigating through an environment that includes a plurality of agents, the plurality of agents including the vehicle and one or more other agents, and the initial future trajectory starting from a current time step and defining respective states of the vehicle at each of a plurality of time steps that are after the current time step;
obtaining respective initial future trajectories for each of the one or more other agents in the environment that each starts from the current time step and defines respective states of the agent at each of the plurality of time steps that are after the current time step;
obtaining, for each of the plurality of agents, data defining a respective cost function of the agent at each of the plurality of time steps based on a respective state of the agent at the time step;
linearizing, for each agent and for each time step, a respective dynamics function that receives at least the respective state of the agent and an action to be performed by the agent at the time step and predicts a respective state of the agent at a following time step;
performing a backward pass through the plurality of time steps starting from the last time step in the respective initial future trajectories until the current time step, comprising at each time step:
generating a respective value function at the time step for each agent of the plurality of agents from at least the respective cost function for the agent at the time step; and
generating a respective optimal agent policy for each agent of the plurality of agents at the time step by minimizing the respective value function for the agent at the time step, wherein the respective optimal agent policy for each agent at the time step depends on the respective states of the plurality of agents at the time step; and
generating an optimized future trajectory for the vehicle by performing a forward pass through the plurality of time steps starting from the current time step until the last time step to select a respective action generated from the respective optimal agent policy for the vehicle at each time step.

20. One or more non-transitory storage media storing instructions that when executed by one or more computers cause the one or more computers to perform operations comprising:
obtaining an initial future trajectory for a vehicle navigating through an environment that includes a plurality of agents, the plurality of agents including the vehicle and one or more other agents, and the initial future trajectory starting from a current time step and defining respective states of the vehicle at each of a plurality of time steps that are after the current time step;
obtaining respective initial future trajectories for each of the one or more other agents in the environment that each starts from the current time step and defines respective states of the agent at each of the plurality of time steps that are after the current time step;
obtaining, for each of the plurality of agents, data defining a respective cost function of the agent at each of the plurality of time steps based on a respective state of the agent at the time step;
linearizing, for each agent and for each time step, a respective dynamics function that receives at least the respective state of the agent and an action to be performed by the agent at the time step and predicts a respective state of the agent at a following time step;
performing a backward pass through the plurality of time steps starting from the last time step in the respective initial future trajectories until the current time step, comprising at each time step:
generating a respective value function at the time step for each agent of the plurality of agents from at least the respective cost function for the agent at the time step; and
generating a respective optimal agent policy for each agent of the plurality of agents at the time step by minimizing the respective value function for the agent at the time step, wherein the respective optimal agent policy for each agent at the time step depends on the respective states of the plurality of agents at the time step; and
generating an optimized future trajectory for the vehicle by performing a forward pass through the plurality of time steps starting from the current time step until the last time step to select a respective action generated from the respective optimal agent policy for the vehicle at each time step.
